(19) United States
(12) Patent Application Publication
(10) Pub. No.: US 2020/0369396 A1
(43) Pub. Date: Nov. 26, 2020

(54) REAR ENGINE ATTACHMENT SYSTEM FOR AN AIRCRAFT ENGINE, HAVING A BEAM MADE IN THREE PARTS

(71) Applicant: Airbus Operations SAS, Toulouse (FR)

(72) Inventors: Christophe LABARTHE, Toulouse (FR); Michael BERJOT, Toulouse (FR); Thomas DEFORET, Toulouse (FR)

(21) Appl. No.: 16/879,121

(22) Filed: May 20, 2020

(30) Foreign Application Priority Data
May 22, 2019 (FR) 1905373

(51) Int. Cl. B64D 27/26

(52) U.S. Cl. CPC B64D 27/26; B64D 2027/264

(57) ABSTRACT

A rear engine attachment system for an aircraft engine. The attachment system has an engine pylon with a lower spar having a lower surface, and a rear engine attachment having a beam fixed against the lower surface and to which a pair of rods is fixed. Each rod is fixed to the beam by at least one first connection point and to the engine by at least one second connection point. The beam includes front and rear fittings, and an intermediate fitting with a shoe and an intermediate clevis. The shoe presses against the lower surface. The front fitting presses against the intermediate fitting at the front and the rear fitting presses against the intermediate fitting at the rear. The fixing to the lower spar is ensured by bolts, each passing through the front base or the rear base, the shoe and the lower spar.

### CROSS-REFERENCES TO RELATED APPLICATIONS

This application claims the benefit of the French patent application No. 1905373 filed on May 22, 2019, the entire disclosures of which are incorporated herein by way of reference.

### FIELD OF THE INVENTION

The present invention relates to a rear engine attachment system for an aircraft engine, and to an aircraft having at least one such rear engine attachment.

### BACKGROUND OF THE INVENTION

An aircraft conventionally has at least one engine, in particular a jet engine. Beneath each wing, and for each engine, the aircraft has an engine pylon that is fixed to the structure of the wing and that extends below the wing, and the engine is suspended beneath the engine pylon.

The engine is fixed to the engine pylon by way of an engine attachment system comprising a front engine attachment and a rear engine attachment.

The rear engine attachment has, for example, a beam that is fixed to a lower surface of the engine pylon and two rods that are fixed between the beam and a rear casing of the engine. At each end, the beam is equipped with bolts that fix it to the engine pylon.

Each rod and the beam define in combination a primary load path between the engine and the engine pylon, so as to withstand the loads of the engine under normal operating conditions of the engine.

Such a beam is a long and bulky component, and although such a beam is satisfactory from the point of view of its use, it is necessary to find a different architecture to make it possible to reduce the bulk, this ultimately making it possible to bring the engine closer to the wing.

### SUMMARY OF THE INVENTION

An object of the present invention is to propose a rear engine attachment system of which the beam is in three parts so as to be more compact, by bringing the pins closer to the bolts that ensure the fixing to the engine pylon and by reducing the length of the beam.

To this end, a rear engine attachment system for an engine of an aircraft is proposed, the rear engine attachment system having:
an engine pylon having, in its lower part, a lower spar having an attachment wall with a lower surface, and
a rear engine attachment having a beam that is fixed against the lower surface and to which a first rod and a second rod are fixed, wherein each rod is fixed to the beam in an articulated manner by at least one first connection point, and is intended to be fixed to the engine in an articulated manner by at least one second connection point,
the rear engine attachment system being characterized in that the beam is made up of a front fitting, a rear fitting and an intermediate fitting, wherein the front fitting is disposed in front of the rear fitting and wherein the intermediate fitting is disposed between the front fitting and the rear fitting, in that the intermediate fitting has a shoe and an intermediate clevis secured to the shoe and realized by a front flank and a rear flank and wherein the shoe has an upper face oriented upward and a lower face oriented downward, in that the upper face of the shoe is pressed against the lower surface of the attachment wall, in that the front fitting takes the form of a bracket and has a front base and a front wall secured to the front base, wherein the front base is pressed against the lower face of the shoe and wherein the front wall is disposed in front of the front flank and pressed against the front flank, in that the rear fitting takes the form of a bracket and has a rear base and a rear wall secured to the rear base, wherein the rear base is pressed against the lower face of the shoe and wherein the rear wall is disposed behind the rear flank and pressed against the rear flank, in that, for each first connection point, the clevis of the beam is formed by the intermediate clevis that is sandwiched between the front wall and the rear wall, in that a pin realizing the first connection point passes in succession through a bore in the front wall, a bore in the front flank, a bore in the corresponding rod, a bore in the rear flank and a bore in the rear wall and in that the beam is fixed to the attachment wall by bolts, wherein each bolt passes through a bore in the front base or in the rear base, a bore in the shoe and a bore in the lower spar.

Such a rear engine attachment system thus has a beam in three parts that forms a more compact assembly and makes it possible to bring the pins closer to the bolts for fixing to the engine pylon.

Advantageously, the rear engine attachment system has a backup safety fixing point that is activated in the event of failure of a primary load path and that creates an auxiliary load path between the engine and the engine pylon, the backup safety fixing point is made up of a clevis provided in the beam and a pin that is fitted into bores in the clevis and that passes through a bore in the engine, of which the diameter is greater than the diameter of the pin, the clevis of the beam is formed by the intermediate clevis that is sandwiched between the front wall and the rear wall, and a pin realizing the backup safety fixing point passes in succession through a bore in the front wall, a bore in the front flank, the bore in the engine, a bore in the rear flank and a bore in the rear wall.

The invention also proposes an aircraft having a structure, an engine and a rear engine attachment system according to one of the preceding variants, wherein the engine pylon is fixed to the structure, and wherein a rear part of the engine is fixed to the at least one second connection point.

### BRIEF DESCRIPTION OF THE DRAWINGS

The abovementioned features of the invention, along with others, will become more clearly apparent on reading the following description of one exemplary embodiment, the description being given with reference to the appended drawings, in which:

FIG. 1 is a side view of an aircraft according to the invention,

FIG. 2 is a perspective view of a rear engine attachment system according to the invention, and

FIG. 3 is an exploded perspective view of the rear engine attachment system in FIG. 2.

### DETAILED DESCRIPTION OF THE PREFERRED EMBODIMENTS

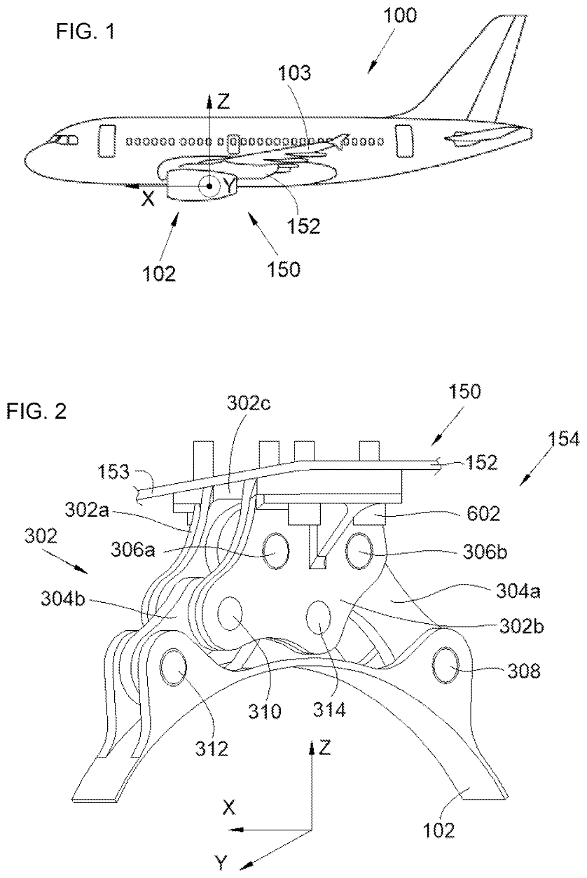

In the following description, terms relating to a position are considered in relation to an aircraft in a position of forward movement, i.e., as shown in FIG. 1.

FIG. 1 shows an aircraft 100, which has an engine 102, in particular, a jet engine.

In the following description, and by convention, the X direction is the longitudinal direction of the engine 102, with positive orientation in the direction of forward movement of the aircraft 100, the Y direction is the transverse direction of the engine 102, which is horizontal when the aircraft is on the ground, and the Z direction is the vertical direction or vertical height when the aircraft is on the ground, these three directions X, Y and Z being mutually orthogonal. The front and rear positions are considered with reference to the front and rear of the aircraft 100.

In the embodiment of the invention that is shown in FIG. 1, the aircraft 100 has an engine 102 beneath each wing 103, but it is possible to provide a plurality of engines beneath each wing 103.

Beneath each wing 103, and for each engine 102, the aircraft 100 has a rear engine attachment system 150 that is fixed to the structure of the wing 103 and extends beneath the wing 103 and supports the rear part of the engine 102.

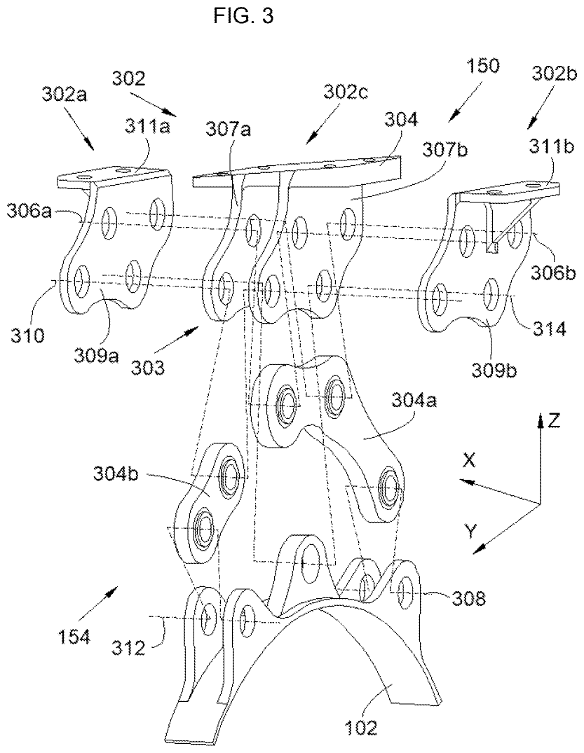

FIGS. 2 and 3 show the rear engine attachment system 150.

The rear engine attachment system 150 comprises an engine pylon 152, which is fixed to the wing 103, and a rear engine attachment 154, which is fixed to the engine pylon 152 and to which the rear part of the engine 102 is fixed.

In a known manner, the engine pylon 152 takes, for example, the form of a box that has, inter alia, in its lower part, a lower spar 153 that extends in a substantially horizontal plane.

The rear engine attachment 154 has a beam 302 to which a first rod 304a and a second rod 304b are fixed.

Each rod 304a-b is fixed to the beam 302 in an articulated manner by at least one first connection point 306a-b, 310, and is fixed to a rear part of the engine 102, which is shown here by a part of its rear casing, in an articulated manner by at least one second connection point 308, 312.

In the embodiment of the invention that is presented here, the lower spar 153 has an attachment wall that has a lower surface oriented toward the bottom of the aircraft 100.

The beam 302 is fixed against the lower surface of the attachment wall, in this case using bolts 602 that pass through a bore in the beam 302 and a bore in the attachment wall. The axes of the bolts 602 are oriented vertically.

In the embodiment of the invention that is presented here, the first rod 304a is fixed to the beam 302 by two first connection points 306a-b and to the engine 102 by a second connection point 308, and the second rod 304b is fixed to the beam 302 by a first connection point 310 and to the engine 102 by a second connection point 312.

For each rod 304a-b, each connection point to the beam 302 and to the engine 102 is formed by a clevis realized, in the beam 302 and the engine 102 respectively, by a bore passing through the rod 304a-b and by a pin that passes through the bores in the clevis and fits into the bore in the rod, wherein the rod is mounted on the pin by way of a ball joint connection.

Each rod 304a-b, the beam 302 and the lower spar 153 define in combination a primary load path between the engine 102 and the engine pylon 152, so as to withstand the loads of the engine 102 under normal operating conditions of the engine 102.

For enhanced safety, the rear engine attachment 154, and more particularly the beam 302, has an additional connection point 314. The additional connection point 314 is, in this case, disposed in the median plane XZ and establishes an additional connection between the beam 302 and the engine 102. The additional connection point 314 takes the form of a backup safety fixing point (or “waiting fail-safe”) that will compensate a failure of the primary load path, i.e., of at least one of the rods 304a-b. This means that when a component of the primary load path is damaged, the activation of the backup safety fixing point creates an auxiliary load path between the engine 102 and the engine pylon 152.

The backup safety fixing point 314 is, in this case, made up of a clevis provided in the beam 302 and a pin that is fitted into bores in the clevis and that passes through a bore in the engine 102, of which the diameter is greater than the diameter of the pin. Thus, in normal operation there is no contact between the pin and the engine 102, and in the event of one of the rods 304a-b breaking, the engine 102 will move and the pin will then come into contact with the engine 102.

According to the invention, the beam 302 is made up of a front fitting 302a, a rear fitting 302b and an intermediate fitting 302c. The front fitting 302a is disposed in front of the rear fitting 302b and the intermediate fitting 302c is disposed between the front fitting 302a and the rear fitting 302b.

The intermediate fitting 302c has a shoe 304 and an intermediate clevis 303 secured to the shoe 304 and realized by a front flank 307a and a rear flank 307b that are parallel, and wherein the front flank 307a is disposed in front of the rear flank 307b. The front and rear flanks 307a-b are perpendicular to the shoe 304. The shoe 304 has an upper face oriented upward and a lower face oriented downward.

The upper face of the shoe 304 is pressed against the lower surface of the attachment wall.

The front fitting 302a takes the form of a bracket and has a front base 311a and a front wall 309a secured to the front base 311a and perpendicular to the front base 311a.

The rear fitting 302b takes the form of a bracket and has a rear base 311b and a rear wall 309b secured to the rear base 311b and perpendicular to the rear base 311b.

The front base 311a is pressed against the lower face of the shoe 304 and the front wall 309a is disposed in front of the front flank 307a and is pressed against the front flank 307a.

The rear base 311b is pressed against the lower face of the shoe 304 and the rear wall 309b is disposed behind the rear flank 307b and is pressed against the rear flank 307b.

Each bolt 602 passes in succession through a bore in the front base 311a or in the rear base 311b, a bore in the shoe 304 and a bore in the lower spar 153. In the embodiment of the invention that is presented here, there are two bolts 602 for the front base 311a and two bolts 602 for the rear base 311b. In this case, the head of the bolt 602 comes to bear against the front base 311a or the rear base 311b and the threaded shank penetrates the engine pylon 152 in order to receive a nut.

Such a superposition of the bases 311a-b and the shoe 304 makes it possible to reduce the length of the beam 302.

For each first connection point 306a-b, 310, the clevis of the beam 302 is formed by the intermediate clevis 303 that is also sandwiched between the front wall 309a and the rear wall 309b. The pin realizing the first connection point 306a-b, 310 thus passes in succession through a bore in the front wall 309a, a bore in the front flank 307a, a bore in the corresponding rod 304a-b, a bore in the rear flank 307b and a bore in the rear wall 309b.

For the backup safety fixing point 314, the clevis of the beam 302 is also formed by the intermediate clevis 303 that is also sandwiched between the front wall 309a and the rear wall 309b. The pin realizing the backup safety fixing point 314 thus passes in succession through a bore in the front wall 309a, a bore in the front flank 307a, the bore in the engine 102, a bore in the rear flank 307b and a bore in the rear wall 309b.

For each of the devises described above, the pin of the clevis is generally parallel to the longitudinal X direction.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A rear engine attachment system for an engine of an aircraft, the rear engine attachment system comprising:
an engine pylon comprising, in its lower part, a lower spar having an attachment wall with a lower surface, and
a rear engine attachment comprising a beam that is fixed against the lower surface and to which a first rod and a second rod are fixed, wherein each rod is fixed to the beam in an articulated manner by at least one first connection point, and is configured to be fixed to the engine in an articulated manner by at least one second connection point,
the beam comprising a front fitting, a rear fitting and an intermediate fitting,
wherein the front fitting is disposed in front of the rear fitting and wherein the intermediate fitting is disposed between the front fitting and the rear fitting,
wherein the intermediate fitting has a shoe and an intermediate clevis secured to the shoe and realized by a front flank and a rear flank and wherein the shoe has an upper face oriented upward and a lower face oriented downward, in that the upper face of the shoe is pressed against the lower surface of the attachment wall,
wherein the front fitting is formed as a bracket and has a front base and a front wall secured to the front base, wherein the front base is pressed against the lower face of the shoe and wherein the front wall is disposed in front of the front flank and pressed against the front flank,
wherein the rear fitting is formed as a bracket and has a rear base and a rear wall secured to the rear base, wherein the rear base is pressed against the lower face of the shoe and wherein the rear wall is disposed behind the rear flank and pressed against the rear flank,
wherein, for each first connection point, the clevis of the beam is formed by the intermediate clevis that is sandwiched between the front wall and the rear wall,
wherein a pin realizing the first connection point passes in succession through a bore in the front wall, a bore in the front flank, a bore in either the first rod or the second rod, a bore in the rear flank and a bore in the rear wall, and
wherein the beam is fixed to the attachment wall by bolts, wherein each bolt passes through a bore in the front base or in the rear base, a bore in the shoe and a bore in the lower spar.

2. The rear engine attachment system according to claim 1, further comprising a backup safety fixing point that is activated in an event of failure of a primary load path and that creates an auxiliary load path between the engine and the engine pylon,
wherein the backup safety fixing point is made up of a clevis provided in the beam and a pin that is fitted into bores in the clevis and that passes through a bore in the engine, of which a diameter is greater than a diameter of the pin,
wherein the clevis of the beam is formed by the intermediate clevis that is sandwiched between the front wall and the rear wall, and
wherein a pin realizing the backup safety fixing point passes in succession through a bore in the front wall, a bore in the front flank, the bore in the engine, a bore in the rear flank and a bore in the rear wall.

3. An aircraft having a structure, an engine and a rear engine attachment system according to claim 1, wherein the engine pylon is fixed to the structure, and wherein a rear part of the engine is fixed to the at least one second connection point.
